(19) United States
(12) Patent Application Publication
(10) Pub. No.: US 2016/0302997 A1
(43) Pub. Date: Oct. 20, 2016

(54) MEDICAL PLUG

(71) Applicant: Jeffrey William Ledel, Shakopee, MN (US)

(72) Inventor: Jeffrey William Ledel, Shakopee, MN (US)

(21) Appl. No.: 15/133,343

(22) Filed: Apr. 20, 2016

Related U.S. Application Data
(60) Provisional application No. 62/149,722, filed on Apr. 20, 2015.

(51) Int. Cl. A61J 1/14

(52) U.S. Cl. CPC A61J 1/1412

(57) ABSTRACT

A plug is provided. The plug includes a body portion made of a foam material. The body portion has the shape of an upside down cone having a top end and a bottom end. At least a first internal tube is formed through the body portion along a longitudinal axis from the top end to the bottom end. The bottom end of the body portion wedges within an opening of a bottle and therefore seals the bottle. A tubing may run through the internal tube of the plug and into the bottle.

### CROSS-REFERENCE TO RELATED APPLICATION

This application claims the benefit of priority of U.S. provisional application No. 62/149,722, filed Apr. 20, 2015, the contents of which are herein incorporated by reference.

### BACKGROUND OF THE INVENTION

The present invention relates to plugs and, more particularly, to a plug used in the medical field.

Currently in the medical file, a bottle and a cap are used during irrigation and insufflation. The cap is made of a hard plastic and includes a threaded portion that screws onto a threaded portion of the bottle. Tubes run through the cap and are typically sealed in place using glue. The current cap system includes relatively expensive manufactured parts and glue, which drives up the cost, making irrigation and insufflation procedures more expensive.

As can be seen, there is a need for an improved cover that reduces the cost of irrigation and insufflation procedures.

### SUMMARY OF THE INVENTION

In one aspect of the present invention, a plug comprises: a body portion comprising a foam material, wherein the body portion comprises an upside down cone shape having a top end and a bottom end, wherein at least a first internal tube is formed through the body portion along a longitudinal axis from the top end to the bottom end.

In another aspect of the present invention, a plug comprises: a body portion comprising a foam material, wherein the body comprises an upside down cone shape having a top end and a bottom end; and a head portion comprising the foam material and extending from the top end of the body portion, wherein the head portion comprises a right-side up cone shape having a top end and a bottom end, wherein the bottom end comprises an outer rim having a larger diameter than the top end of the body portion, wherein at least a first internal tube is formed through the body portion and the head along a longitudinal axis from a top end of the head to the bottom end of the body portion.

These and other features, aspects and advantages of the present invention will become better understood with reference to the following drawings, description and claims.

### BRIEF DESCRIPTION OF THE DRAWINGS

FIG. 1 is a top perspective of an embodiment of the present invention;

FIG. 2 is a bottom perspective view of an embodiment of the present invention;

FIG. 3 is a side view of an embodiment of the present invention;

FIG. 4 is a section view of an embodiment of the present invention taken along line 4-4 in FIG. 1;

FIG. 5 is a top perspective of an embodiment of the present invention;

FIG. 6 is a bottom perspective view of an embodiment of the present invention;

FIG. 7 is a section view of an embodiment of the present invention taken along line 7-7 in FIG. 5;

FIG. 8 is a section view of an embodiment of the present invention illustrated in an upside down position when used for insufflations; and

FIG. 9 is a top perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

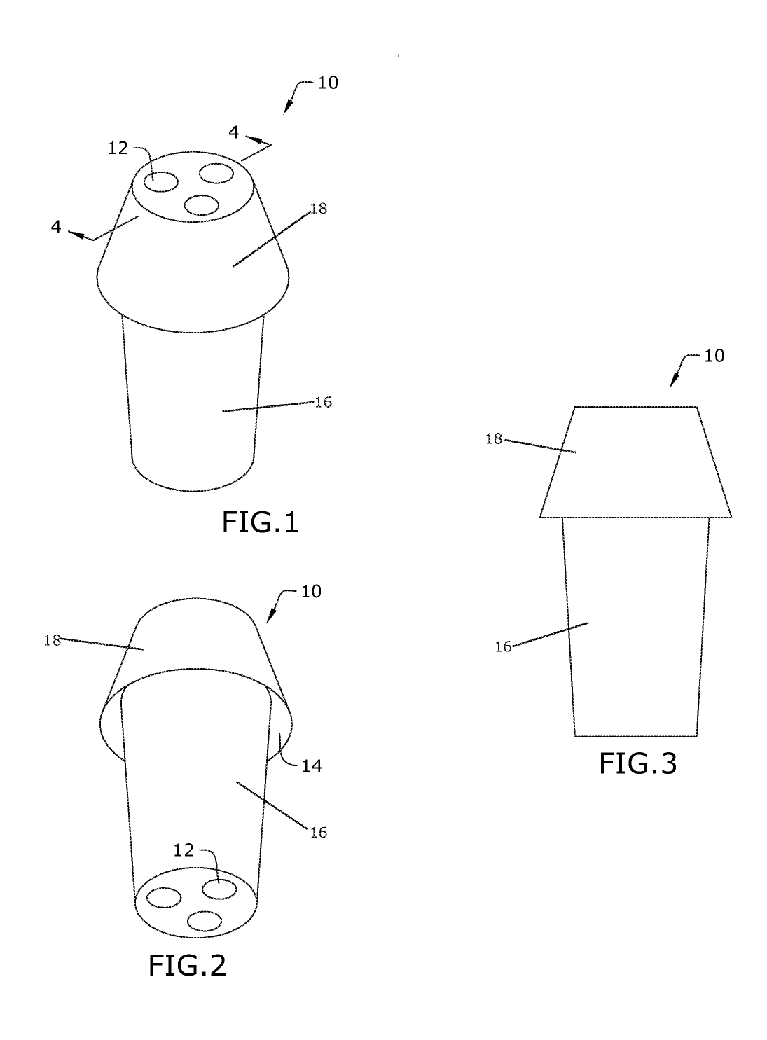

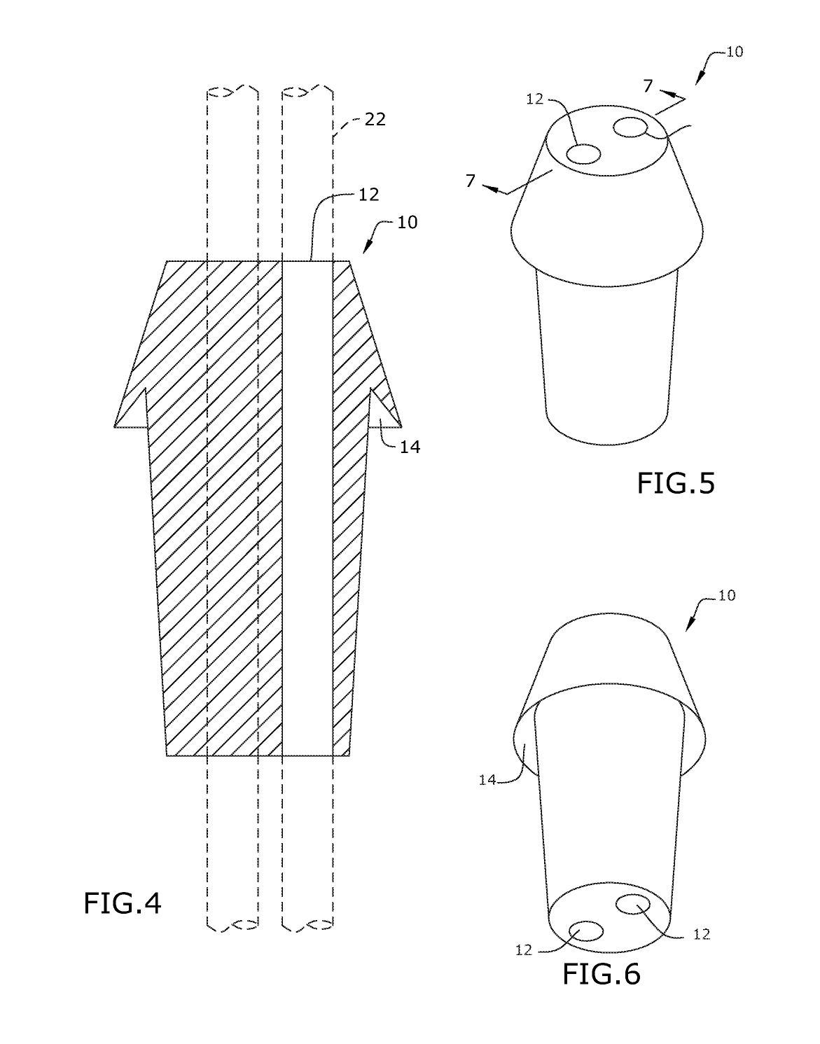

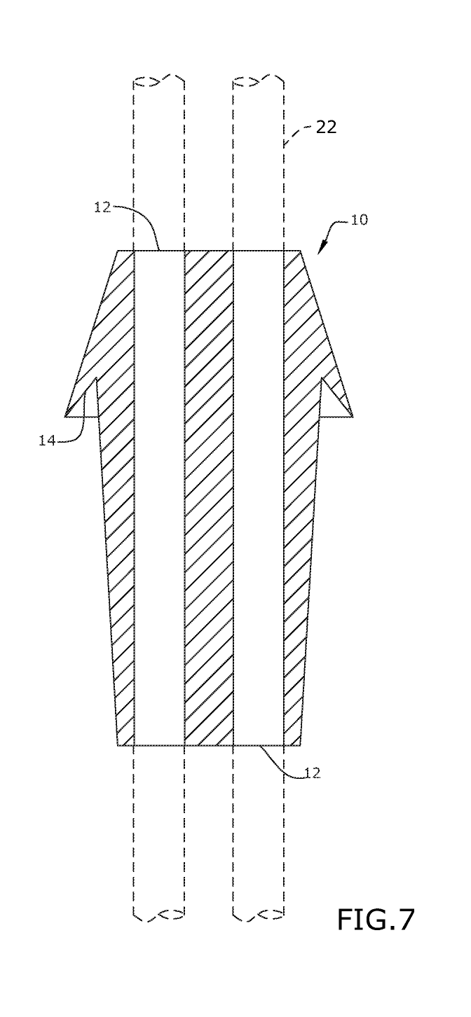

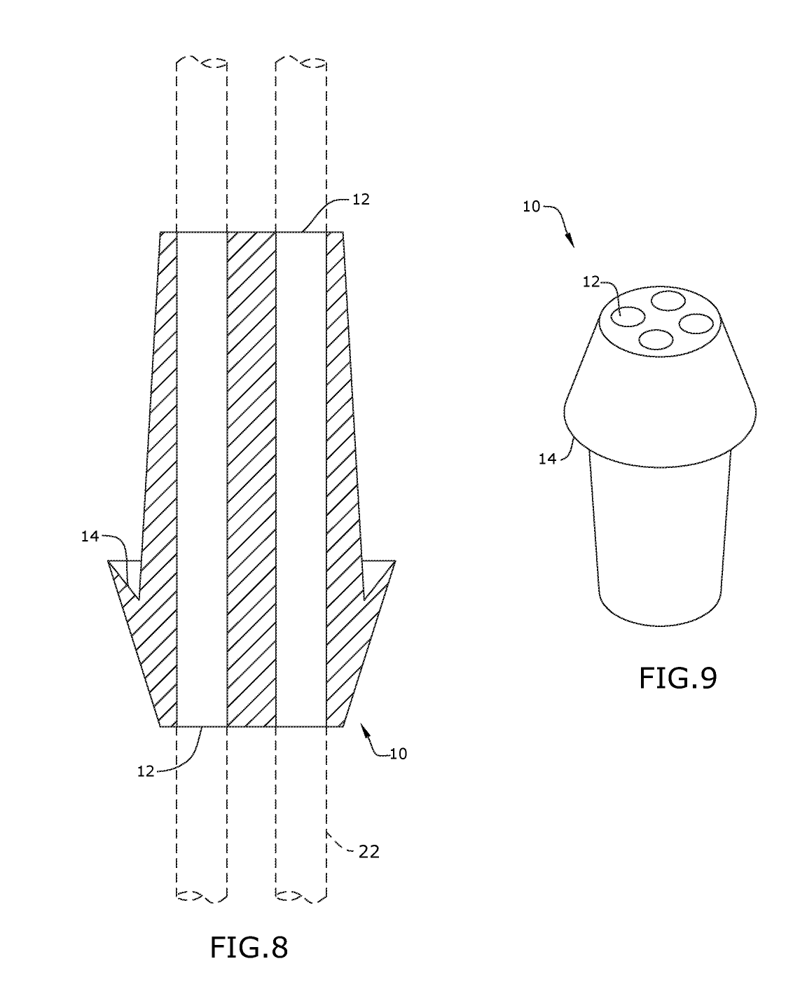

Referring to FIGS. 1 through 7, the present invention includes a plug 10. The plug 10 includes a body portion 16 having a rubber elasticity. The body portion 16 has the shape of an upside down cone having a top end and a bottom end. At least a first internal tube 12 is formed through the body portion 16 along a longitudinal axis from the top end to the bottom end. The bottom end of the body portion 16 wedges within an opening of a bottle and therefore seals the bottle. A tubing 22 may run through the internal tube 12 of the plug 10 and into the bottle.

As mentioned above, the body portion 16 of the present invention includes an upside down cone shape, and is thereby a cylinder that tapers from the top end to the bottom end. The upside down cone shape allows the present invention to fit in different sized openings. Further, the upside down cone shape allows the plug 10 to wedge within the opening, compressing the body portion 16 and thereby forming an air tight seal. In certain embodiments, the bottom end of the body portion 16 may be substantially flat and perpendicular to the internal tube 12. The opening leading into the internal tube 12 is formed through the substantially flat bottom end.

The body portion 16 of the present invention may be made of a foam material or rubber like molded materials. The foam material of the present invention may be any type of foam. The foam material of the present invention may include a closed cell foam. For example, the closed cell foam may be a silicon foam, polypropylene foam or the like. The rubber like molded material may be a silicone rubber material. The foam material includes a rubber elasticity in which the foam is deformable to wedge within the opening of the bottle but biases to its original form. Therefore, the foam applies a pressure against the rim of the bottle, forming the airtight seal mentioned above.

The present invention may include a head portion 18. The head portion 18 is made of the foam material and extends from the top end of the body portion 16. The head portion 18 has the shape of a right-side up cone having a top end and a bottom end. Therefore, the head portion is in the shape of a cylinder that tapers from the bottom end to the top end. In such embodiments, the first internal tube 12 is formed through the body portion 16 and the head portion 18 along a longitudinal axis from a top end of the head portion 18 to the bottom end of the body portion 16.

In certain embodiments, the top end of the head portion 18 may be substantially flat and perpendicular to the internal tube 12. The opening leading into the internal tube 12 is formed through the substantially flat top end. The bottom end of the body portion 16 and the top end of the head portion 18 may be disposed along substantially parallel planes.

In certain embodiments, the bottom end of the head portion 18 includes an outer rim 14 having a larger diameter than the top end of the body portion 16. The outer rim 14 is disposed circumferentially around the body portion 16. In certain embodiments, a portion of the top end of the body portion 16 is disposed within the rim forming a space in between. The rim may be angled away from the body portion 16. As illustrated in the Figures, the outer rim 14 may protrude outward, but could be a simple angled foam plug.

As mentioned above, the internal tubes 12 of the present invention are sized to receiver rubber or silicon tubing 22 within. The plug 10 of the present invention may include one internal tube 12. However, the present invention may include a plurality of internal tubes 12, such as two, three or four internal tubes 12, depending on what the plug 10 is used for. The tubing 22 may fit through an opening formed on the top end of the head portion 18, through the internal tube 12, and then out through an opening formed on the bottom end of the body portion 16. In certain embodiments, slits may be formed through the sidewall of the plug 10. Therefore, the tubes 22 may be urged through the slits and into the internal tube 12.

When using the present invention for irrigation, the user may wedge the body portion 16 of the plug 10 within a new disposable sterile water bottle. The plug 10 may be gently pushed inward until the foam seals the water bottle. A tubing 22 may run through the internal tube 12 of the plug 10. An outside end of the tubing may be connected with a luer lock connector on the scope and may run through an existing irrigation pump.

When using the present invention for insufflation, the user may wedge the head portion 18 into the water bottle gently pushing in until the foam rim 14 passes through the water bottle neck. The user may then gently pull up to seed the foam plug 10 to the water bottle. The tubing 22 is then connected to the existing scope. The air insufflation and/or C02 connectors are connected to the Endoscopy scope. Alternatively, the irrigation tubing 22 may also be connected to the irrigation pump and to the endoscopy scope.

It should be understood, of course, that the foregoing relates to exemplary embodiments of the invention and that modifications may be made without departing from the spirit and scope of the invention as set forth in the following claims.

What is claimed is:

1. A plug comprising:
a body portion comprising a rubber elasticity, wherein the body portion comprises an upside down cone shape having a top end and a bottom end, wherein
at least a first internal tube is formed through the body portion along a longitudinal axis from the top end to the bottom end.

2. The plug of claim 1, wherein the bottom end is flat.

3. The plug of claim 1, further comprising a head portion comprising the rubber elasticity and extending from the top end of the body portion, wherein the first internal tube extends through the head portion.

4. The plug of claim 3, wherein the head portion comprises a right-side up cone shape.

5. The plug of claim 4, wherein a top end of the head portion is flat.

6. The plug of claim 3, wherein a bottom end of the head portion comprises an outer rim comprising a larger diameter than the top end of the body portion.

7. The plug of claim 6, wherein the outer rim is disposed circumferentially around the body and a portion of the top end of the body is disposed within the rim forming a space in between.

8. The plug of claim 7, wherein the rim is angled away from the body portion.

9. The plug of claim 1, further comprising a second internal tube formed through the body portion along a longitudinal axis from the top end to the bottom end.

10. The plug of claim 9, further comprising a third internal tube formed through the body portion along a longitudinal axis from the top end to the bottom end.

11. The plug of claim 1, wherein the body portion is formed of a foam material.

12. The plug of claim 11, wherein the foam material is a polypropylene closed cell foam.

13. A plug comprising:
a body portion comprising a foam material, wherein the body comprises an upside down cone shape having a top end and a bottom end; and
a head portion comprising the foam material and extending from the top end of the body portion, wherein the head portion comprises a right-side up cone shape having a top end and a bottom end, wherein the bottom end comprises an outer rim having a larger diameter than the top end of the body portion, wherein
at least a first internal tube is formed through the body portion and the head portion along a longitudinal axis from a top end of the head portion to the bottom end of the body portion.

14. The plug of claim 13, wherein the outer rim is disposed circumferentially around the body so that a portion of the top end of the body is disposed within the rim forming a space in between.

15. The plug of claim 14, wherein the rim is angled away from the body portion.

16. The plug of claim 13, further comprising a second internal tube formed through the body portion and the head along a longitudinal axis from the top end of the head to the bottom end of the body portion.

17. The plug of claim 16, further comprising a third internal tube formed through the body portion and the head along a longitudinal axis from the top end of the head to the bottom end of the body portion.

18. The plug of claim 13, wherein the foam material is a closed cell foam.

19. The plug of claim 18, wherein the closed cell foam is a silicon closed cell foam.

20. The plug of claim 13, wherein the bottom end of the body portion and the top end of the head are flat and are disposed along substantially parallel planes.
